(19) United States
(12) Patent Application Publication
(10) Pub. No.: US 2009/0251744 A1
(43) Pub. Date: Oct. 8, 2009

(54) AUTO DOCUMENT FEEDING DEVICE AND IMAGE SCANNING DEVICE

(75) Inventor: Akihito TOKUTSU, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/413,192

(22) Filed: Mar. 27, 2009

Related U.S. Application Data
(60) Provisional application No. 61/042,226, filed on Apr. 3, 2008.

(51) Int. Cl. H04N 1/04

(52) U.S. Cl. 358/498

(57) ABSTRACT

An OUT conveying member and an IN conveying member which reach pre-scan rollers from a document tray are provided. In the case of continuously conveying a document, while a preceding document is conveyed by one conveying member, a following document is caused to stand by in the other conveying member. The documents are conveyed in the state where the distance between the preceding document and the following document is close to 0 mm.

### CROSS-REFERENCE TO RELATED APPLICATION

This application is based upon and claims the benefit of priority from provisional U.S. Application 61/042,226 filed on Apr. 3, 2008, the entire contents of which are incorporated herein by reference.

### TECHNICAL FIELD

The present invention relates to an auto document feeding device which conveys a document to an image scanning device used for a copy machine, printer or the like and particularly enables high-speed scanning.

### BACKGROUND

In an image scanning device such as a scanner used for an image forming apparatus such as a copy machine or printer, increase in the image scanning speed is required. Conventionally, there is a device in which plural document scanning conveying paths are formed and in which a scanning sensor for scanning a face-side image of the document and a scanning sensor for scanning a back-side image are provided in each conveying path, thereby increasing the scanning speed at the time of double-side scanning of the document images. As such an image scanning device, for example, JP-ACT2006-168972 discloses a device having a first branch path through which a document is conveyed to a first scanning position, and a second branch path through which a document is conveyed to a second scanning position. Moreover, for example, JP-ACT2004-15299 discloses a device which has a scanner device and a CIS (contact image sensor) provided on the opposite sides of a first conveying path and simultaneously uses the scanner device and the CIS to scan both sides of a document conveyed on the first conveying path.
However, none of the above devices can obtain higher speeds in the case of continuous scanning of a document.

Development of a document feeding device which conveys a document to an image scanning position at a high speed when continuously scanning the document, thus efficiently scans the document and hence realizes higher image scanning speeds is desired.

### SUMMARY

According to an aspect, a document is continuously conveyed to an image scanning member in order to eliminate a state where the image scanning member waits for the document to be conveyed.

According to an aspect, an auto document feeding device includes plural conveying members which have different paths to reach an image scanning member for scanning an image on a first side of a document from a document stacking member and which guide the document from the document stacking member to the image scanning member, a gate member which divides the document passed through a registration roller for aligning a forward end of the document from the document stacking member to one of the plural conveying members, and a paper discharge member which discharges the document passed through the image scanning member.

### DESCRIPTION OF THE DRAWINGS

FIG. 1 is a configuration view schematically showing an image scanning device according to an embodiment;

FIG. 2 is a block diagram showing a control system of an ADF according to the embodiment;

FIG. 3 is a flowchart showing operations from turning on power to starting supply of a document according to the embodiment;

FIG. 4 is a flowchart showing operations to supply the document and convey the document to an OUT conveying member according to the embodiment;

FIG. 5 is a flowchart showing an operation to convey the document by using the OUT conveying member according to the embodiment;

FIG. 6 is a flowchart showing operations from the start of scanning of an image to the end of scanning;

FIG. 7 is a flowchart showing an operation to convey a following document by using an IN conveying member according to the embodiment;

FIG. 8 is a flowchart showing completion of the conveying according to the embodiment;

FIG. 9 is an explanatory view showing the state where supply of the first sheet of the document is started according to the embodiment;

FIG. 10 is an explanatory view showing the state where the first sheet of the document is conveyed to the OUT conveying member according to the embodiment;

FIG. 11 is an explanatory view showing the standby of the first sheet of the document in the OUT conveying member according to the embodiment;

FIG. 12 is an explanatory view showing the state where supply of the second sheet of the document is started according to the embodiment;

FIG. 13 is an explanatory view showing the state where the second sheet of the document is conveyed to the IN conveying member according to the embodiment;

FIG. 14 is an explanatory view showing the state where the second sheet of the document following the first sheet of the document is conveyed according to the embodiment;

FIG. 15 is an explanatory view showing the distance between the first sheet and the second sheet of the document according to the embodiment;

FIG. 16 is an explanatory view showing the state where supply of the third sheet of the document is started according to the embodiment; and

FIG. 17 is an explanatory view showing the state where the third sheet of the document is conveyed to the OUT conveying member according to the embodiment.

### DETAILED DESCRIPTION

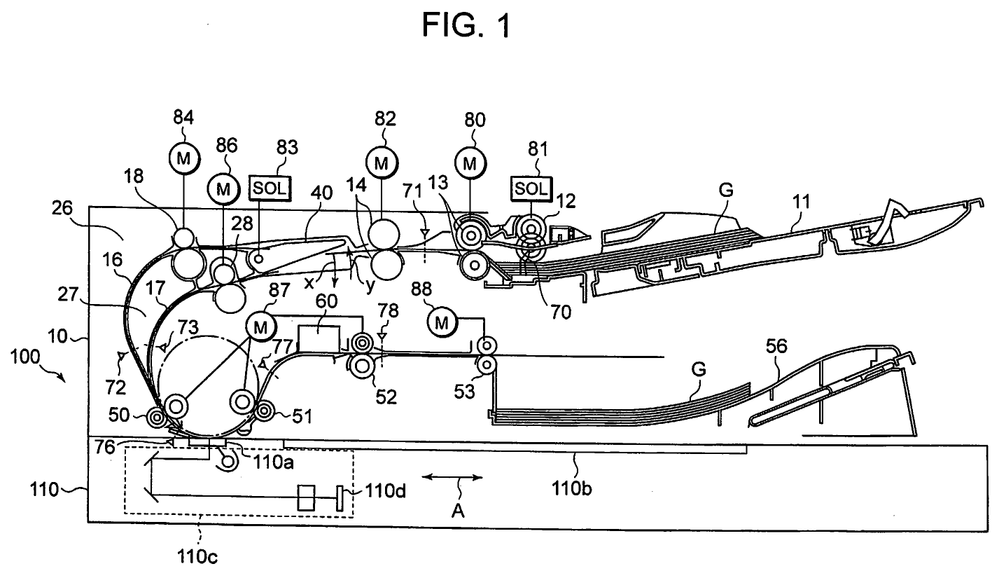

Hereinafter, an embodiment will be described. FIG. 1 shows an image scanning device 100 according to the embodiment. The image scanning device 100 has a scanner 110, which is an image scanning member, and an auto document feeding device (ADF) 10 which conveys a document G to the scanner 110. The scanner 110 has a READ document glass 110a and a platen glass 110b of a document setting table. The scanner 110 also has an optical mechanism 110c. The optical mechanism 110c optically scans an image of the document G traveling on the READ document glass 110a. Alternatively, the optical mechanism 110c is caused to move in the direction of arrow A (see FIG. 1) by a driving unit, not shown, along the platen glass 110b, and optically scans the image of the document G set on the platen glass 110b. The scanner 110 has a CCD (charge coupled device) 110d which photoelectrically converts an optical signal from the optical mechanism 110c to an electric signal.

The auto document feeding device 10 has a document tray 11, which is a document stacking member, a pickup roller 12 which takes out the document G from the document tray 11, separation paper supply rollers 13 which prevent double feed of the document G, and registration rollers 14 which align the forward end of the document G taken out and conveyed from the document tray 11. The auto document feeding device 10 has two paths as conveying paths, that is, an OUT path 16 from the registration rollers 14 to the scanner 110, and an IN path 17 from the registration rollers 14 to the scanner 110. The OUT path 16, together with the document tray 11, the pickup roller 12, the separation paper supply rollers 13 and the registration rollers 14, forms an OUT conveying member 26, as a first conveying member, for example. The IN path 17, together with the document tray 11, the pickup roller 12, the separation paper supply rollers 13 and the registration rollers 14, forms an IN conveying member 27, as a second conveying member, for example.

The OUT path 16 has intermediate OUT rollers 18. The IN path 17 has intermediate IN rollers 28. The auto document feeding device 10 has a gate 40 which divides the document G taken out from the document tray 11 and passed through the registration rollers 14, to the OUT path 16 or the IN path 17.

The auto document feeding device 10 has pre-scan rollers 50 which conveys the document G passed through the OUT path 16 or the IN path 17 to the READ document glass 110a of the scanner 110, post-scan rollers 51 which discharges the document G from the READ document glass 110a, pre-discharge rollers 52, paper discharge rollers 53, and a paper discharge tray 56. The post-scan rollers 51, the pre-discharge rollers 52 and the paper discharge rollers 53 form a paper discharge member. A contact image sensor (CIS) 60, which is a second image scanning member, is provided between the post-scan rollers 51 and the pre-discharge rollers 52. This contact image sensor (CIS) 60 may be provided in a conveying path upstream of the paper discharge rollers 53.

On the READ document glass 110a, an image on the face side as a first side of the traveling document G is scanned. The CIS 60 scans an image on the back side as a second side of the traveling document G. Thus, it is possible to scan the images on both sides of the document G by passing the document once.

An empty sensor 70 which detects the presence or absence of the document G is provided above the document tray 11. A registration sensor 71 which detects arrival of the document G at the registration rollers 14 is provided between the separation paper supply rollers 13 and the registration rollers 14. In the OUT path 16, a paper timing sensor OUT 72 as a first timing sensor which detects the drive timing of the registration rollers 14 and the intermediate OUT rollers 18 is provided. In the IN path 17, a paper timing sensor IN 73 as a second timing sensor which detects the drive timing of the registration rollers 14 and the intermediate IN rollers 28 is provided.

A pre-scan sensor 76 is provided between the pre-scan rollers 50 and the READ document glass 110a. A scan sensor 77 is provided between the post-scan rollers 51 and the pre-discharge rollers 52. A paper discharge sensor 78 is provided between the pre-discharge rollers 52 and the paper discharge rollers 53.

The pickup roller 12 and the separation paper supply rollers 13 are driven to rotate by a paper supply motor 80. The pickup roller 12 is caused to fluctuate by a pickup solenoid 81. The registration rollers 14 are driven to rotate by a registration motor (RGT motor) 82. The gate 40 is switched by a gate solenoid 83. When the gate solenoid 83 is turned off, the gate 40 turns in the direction of arrow x and divides the document G to the OUT conveying member 26. When the gate solenoid 83 is turned on, the gate 40 turns in the direction of arrow y and divides the document G to the IN conveying member 27.

The intermediate OUT rollers 18 are driven to rotate by an intermediate OUT motor 84. The intermediate IN rollers 28 are driven to rotate by an intermediate IN motor 86. The pre-scan rollers 50, the post-scan rollers 51 and the pre-discharge rollers 52 are driven to rotate by a READ motor 87. The paper discharge rollers 53 are driven to rotate by a paper discharge motor 88.

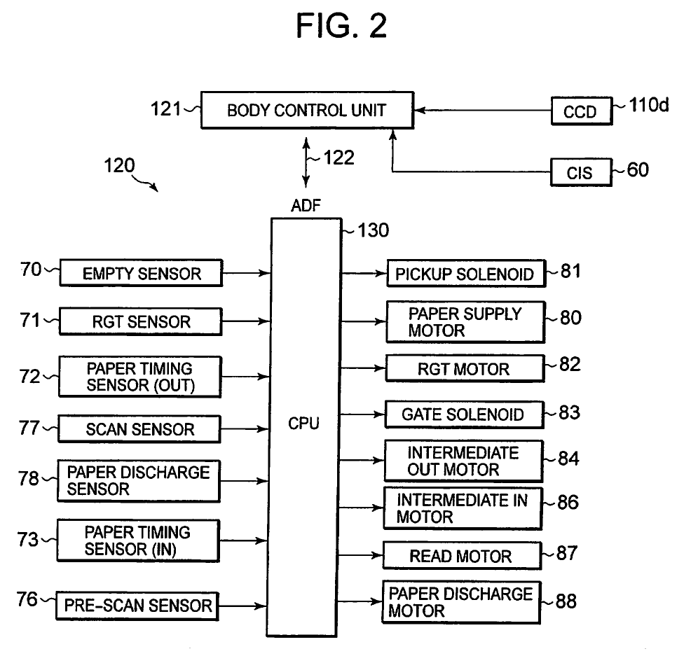

FIG. 2 shows a block diagram of a control system 120 mainly for the ADF 10. The CCD 110d of the scanner 110 and the CIS 60 are connected to a body control unit 121 which controls, for example, an entire image forming apparatus having the image scanning device 100. The body control unit 121 controls a CPU 130 of the ADF 10 via an input-output interface 122. The empty sensor 70, the registration sensor 71, the paper timing sensor OUT 72, the paper timing sensor IN 73, the pre-scan sensor 76, the scan sensor 77 and the paper discharge sensor 78 are connected to the input side of the CPU 130.

The pickup solenoid 81, the paper supply motor 80, the RGT motor 82, the gate solenoid 83, the intermediate OUT motor 84, the intermediate IN motor 86, the READ motor 87 and the paper discharge motor 88 are connected to the output side of the CPU 130.

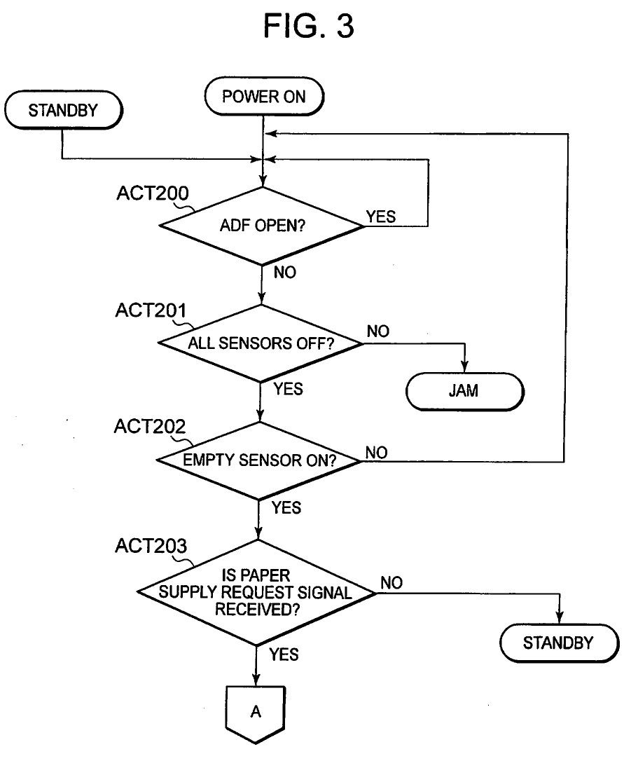

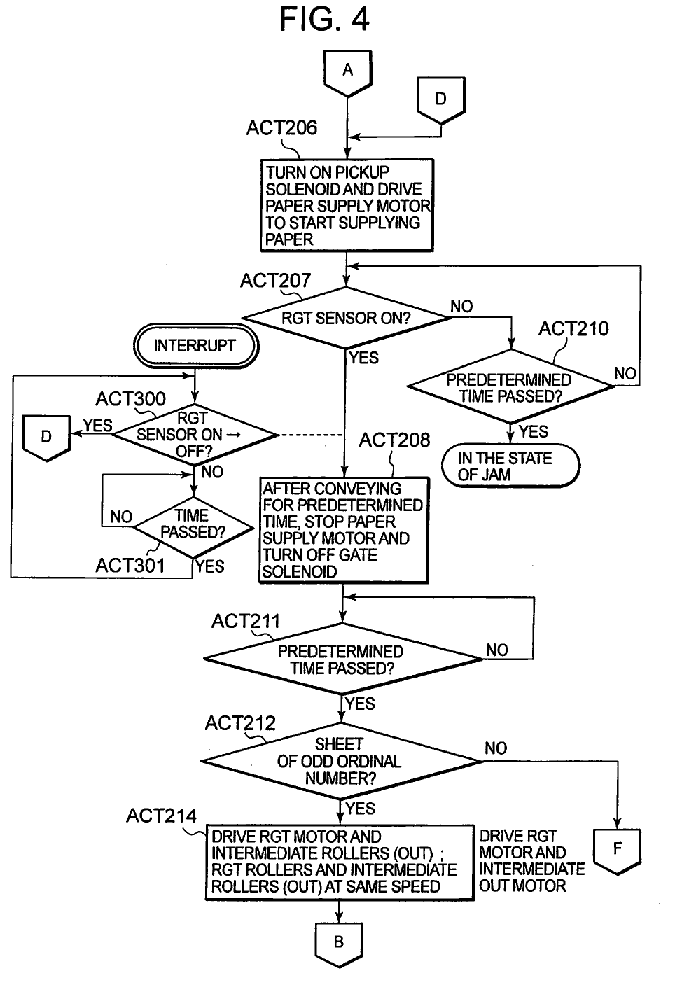

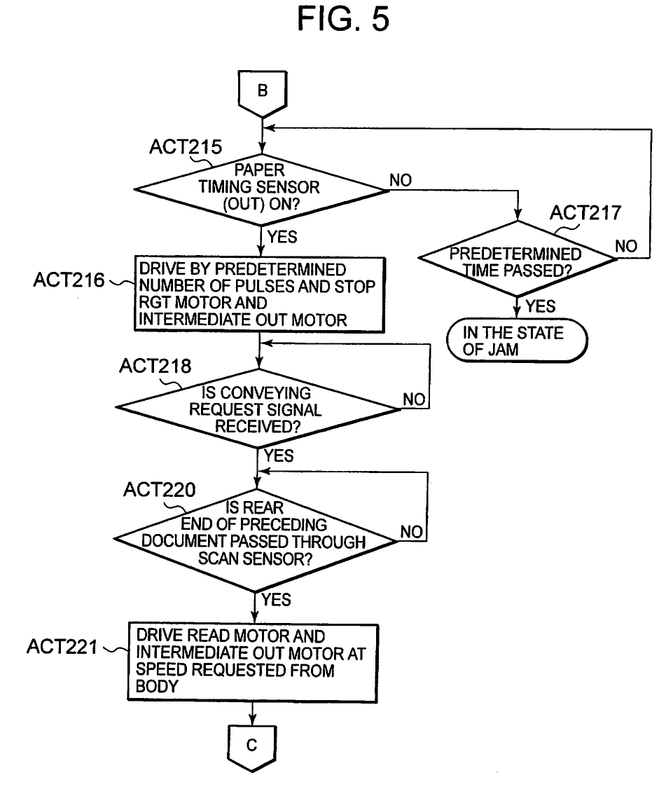

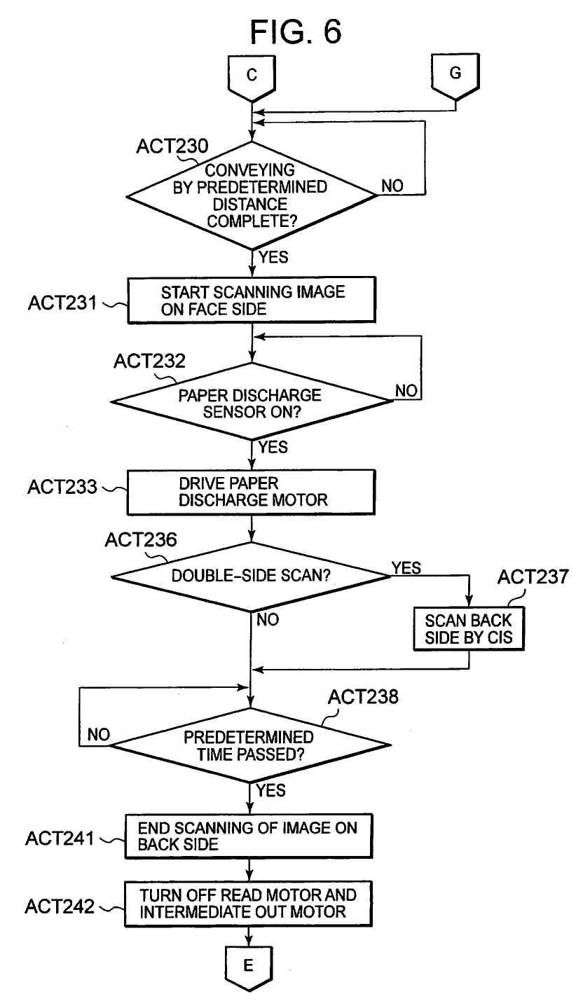

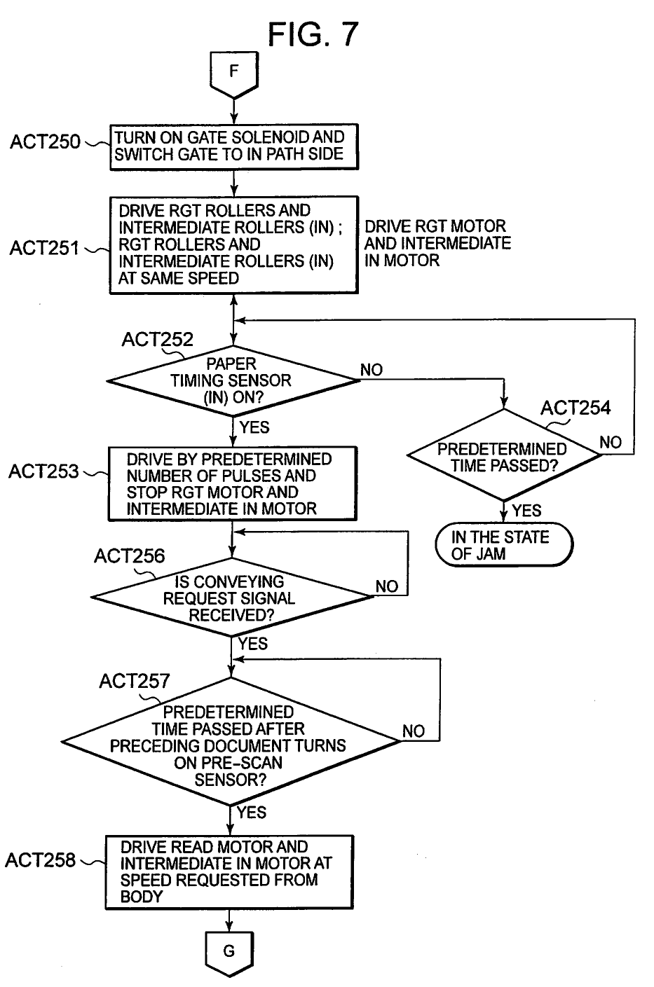

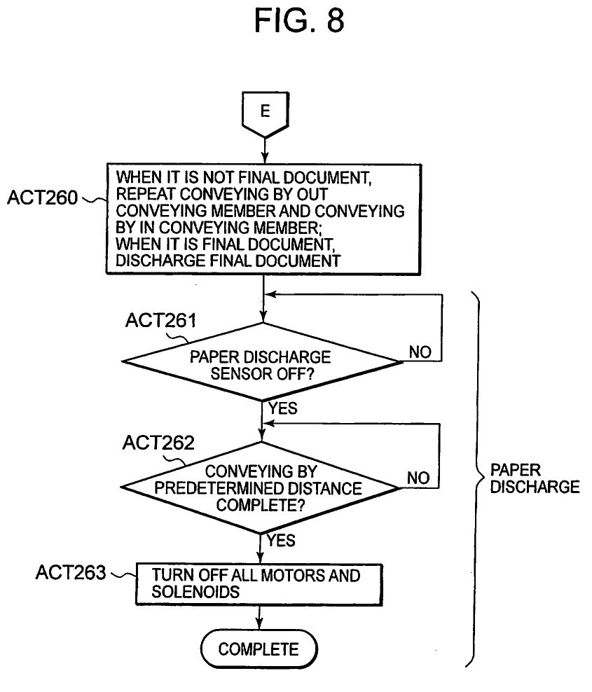

A process of continuously conveying the document G will be described with reference to the flowcharts of FIG. 3 to FIG. 8. After power is turned on, it is confirmed in ACT200 that the ADF 10 is closed. Detection is conveyed out at all the sensors in ACT201 to confirm that there is no jam of documents in the ADF 10. When the document G is set on the document tray 11 in ACT202, the empty sensor 70 turns on and sends a document-on signal to the body control unit 121. After a paper supply request signal is received from the body control unit 121 in ACT203, the processing goes to ACT206.

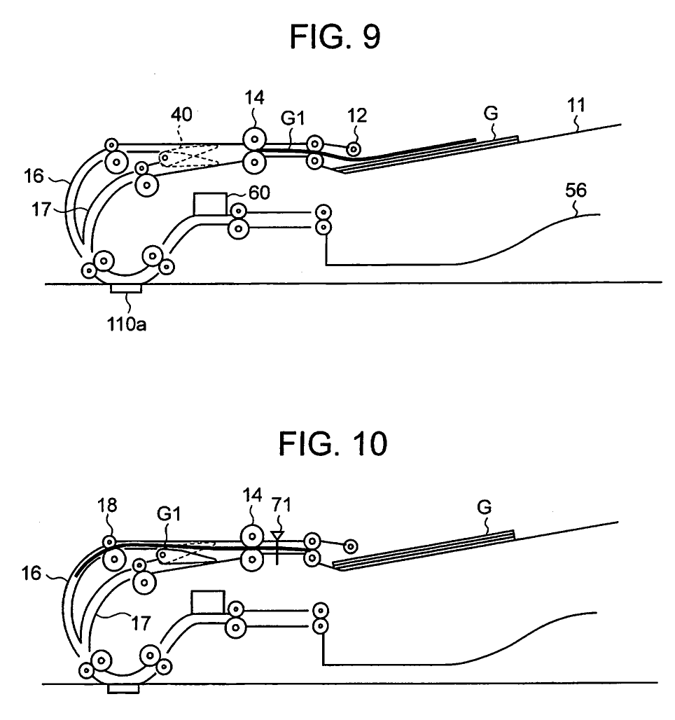

In ACT206, the pickup solenoid 81 is turned on and the paper supply motor 80 is turned on to rotate the pickup roller 12 and the separation paper supply rollers 13. Thus, supply of the document G1 as the first sheet (the first document G1) is started. When the registration sensor 71 turns on in ACT207, the document G1 is conveyed for a predetermined time and then the paper supply motor 80 is turned off and the gate solenoid 83 is turned off (ACT208). As shown in FIG. 9, the first document G1 runs into the registration rollers 14 and its forward end is aligned And then the first document G1 stops. The gate 40 is set in the direction of dividing the first document G1 to the OUT conveying member 26. If the registration sensor 71 does not turn on even after the lapse of a predetermined time in ACT210, it is judged that the document G1 causes jam.

When the registration sensor 71 turns on in ACT207, the supply process of the document G2 as the second sheet (the second document G2) starts as an interrupt process, separately from and parallel to the conveying process of the first document G1. However, the supply process of the second document G2 stands by until the rear end of the first document G1 passes through the registration sensor 71. After the registration sensor 71 changes from on to off in ACT300 (ACT301), the processing goes to ACT206 and supply of the second document G2 starts.

After a predetermined time passes in ACT211 and the document G1 is a sheet of an odd ordinal number (ACT212), the RGT motor 82 and the intermediate OUT motor 84 are turned on to rotate the registration rollers 14 and the intermediate OUT rollers 18 (ACT214) respectively. The intermediate OUT rollers 18 are adjusted to the rotation speed of the registration rollers 14, and the registration rollers 14 and the intermediate OUT rollers 18 are rotated at a uniform velocity. As shown in FIG. 10, the first document G1 is divided by the gate 40 and moves to the OUT conveying member 26.

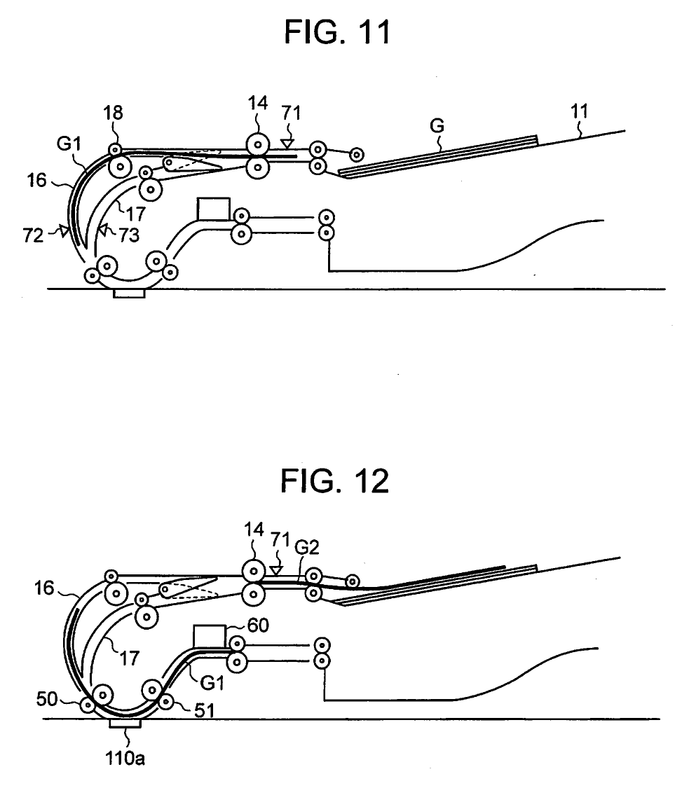

When the paper timing sensor OUT 72 turns on in ACT215, the RGT motor 82 and the intermediate OUT motor 84 are driven for a predetermined number of pulses and then stopped (ACT216). As shown in FIG. 11, the first document G1 stops before the pre-scan rollers 50. If the paper timing sensor OUT 72 does not turn on even after the lapse of a predetermined time in ACT217, it is judged that the document G1 causes jam.

After a conveying request signal is received from the body control unit 121 in ACT218, the processing goes to ACT220. When the scanner 110 can scan, the body control unit 121 sends a conveying request signal to the CPU 130. When there is a preceding document G, and when passes a predetermined time after the forward end of the preceding document G turns on the pre-scan sensor 76 (ACT220), the processing goes to ACT221.

In ACT221, the READ motor 87 and the intermediate OUT motor 84 are turned on to rotate the intermediate OUT rollers 18, the pre-scan rollers 50, the post-scan rollers 51 and the pre-discharge rollers 52 at a speed according to an instruction from the body control unit 121. The timing when the rear end of the preceding document G passes the pre-scan rollers 50 and the timing when the forward end of the first document G1 starts conveying by the pre-scan rollers 50 are caused to coincide with each other. The first document G1 is conveyed to the READ document glass 110a in the state where the distance from the rear end of the preceding document G is close to 0 mm.

After the first document G1 is conveyed by a predetermined distance (ACT230), a scan start signal is sent to the body control unit 121. The body control unit 121 causes the scanner 110 to start scanning an image on the face side of the document G1 (ACT231).

In parallel, when the rear end of the first document G1 passes through the registration sensor 71 and the registration sensor 71 changes from on to off, supply of the second document G2 is started in ACT300. As shown in FIG. 12, the first document G1 travels on the READ document glass 110a. The scanner 110 scans an image of the first document G1. The second document G2 runs into the registration rollers 14 and its forward end is aligned. And then the second document G2 stops.

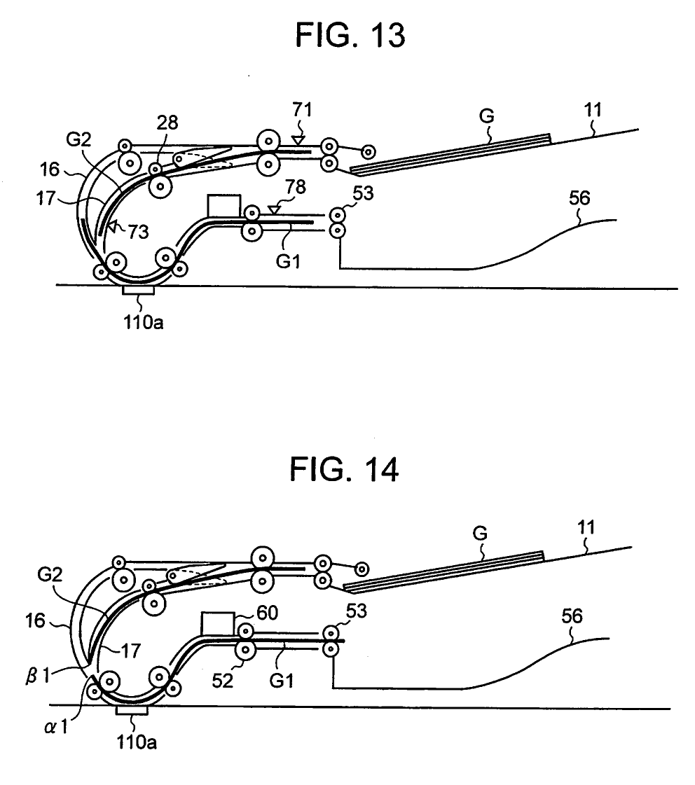

To convey the second document G2 in parallel, when the registration sensor 71 turns on (ACT207), the processing reaches ACT212 via ACT208 and ACT211. In ACT212, if the document G2 is a sheet of an even ordinal number, the processing goes to ACT250. In ACT250, the gate solenoid 83 is turned on and the gate 40 is thus switched to the direction to divide the second document G2 to the IN conveying member 27. Then, in ACT251, the RGT motor 82 and the intermediate IN motor 86 are turned on to rotate the registration rollers 14 and the intermediate IN rollers 28. The intermediate IN rollers 28 are adjusted to the rotation speed of the registration rollers 14, and the registration rollers 14 and the intermediate IN rollers 28 are rotated at a uniform velocity. As shown in FIG. 13, the second document G2 is divided by the gate 40 and moves to the IN conveying member 27.

In ACT231, the first document G1 continues traveling on the READ document glass 110a and the scanner 110 continues scanning the image. The first document G1 is conveyed in the direction of the paper discharge rollers 53 via the post-scan rollers 51 and the pre-discharge rollers 52.

When the first document G1 turns on the paper discharge sensor 78 (ACT232), the paper discharge motor 88 is driven to rotate the paper discharge rollers 53. In the case of double-side scan (Yes in ACT236), the processing goes to ACT237. In ACT237, an image on the back side of the first document G1 conveyed in the paper discharge direction is scanned by the CIS 60. When a predetermined time passes (ACT238) after the paper discharge sensor 78 is turned on, image scanning on the face side of the first document G1 by the scanner 110 is finished (ACT241). After the rear end of the document is passed through the rollers 51, the READ motor 87 and the intermediate OUT motor 84 are turned off (ACT242).

In parallel, with respect to the second document G2, when the paper timing sensor IN 73 is turned on in ACT252, the RGT motor 82 and the intermediate IN motor 86 are driven by a predetermined number of pulses and then stopped (ACT253). The second document G2 is stopped before the pre-scan rollers 50 in the IN conveying member 27. If the paper timing sensor IN 73 does not turn on even after passes a predetermined time in ACT254, it is judged that the document G1 causes jam. After a conveying request signal for the second document G2 is received from the body control unit 121 in ACT256, the processing goes to ACT257.

When a predetermined time passes after the forward end of the preceding document G (the first document G1) turns on the pre-scan sensor 76 in ACT257, the processing goes to ACT258. In ACT258, the READ motor 87 and the intermediate IN motor 86 are turned on and the intermediate IN rollers 28, the pre-scan rollers 50, the post-scan rollers 51 and the paper discharge rollers 52 are rotated at a speed according to an instruction from the body control unit 121. The timing when the rear end of the preceding document G (the first document G1) passes the pre-scan rollers 50 and the timing when the forward end of the second document G2 starts the conveying by the pre-scan rollers 50 are caused to coincide with each other. As shown in FIG. 14, the second document G2 is conveyed to the READ document glass 110a in the state where the distance between the rear end α1 of the preceding document G (the first document G1) and the forward end β1 of the second document G2 is close to 0 mm.

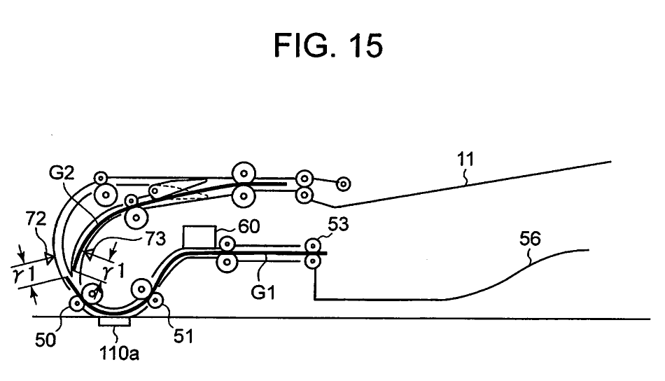

To realize the state where the distance between the rear end α1 of the preceding document G (the first document G1) and the forward end β1 of the second document G2 is close to 0 mm, for example, the distance from the paper timing sensor OUT 72 to the pre-scan rollers 50 and the distance from the paper timing sensor IN 73 to the pre-scan rollers 50 are set to be equal. As shown in FIG. 15, after the paper timing sensor IN 73 is turned on, the second document G2 waits at a position advanced by a predetermined distance γ1. When the rear end of the preceding document G (the first document G1) is passed through the paper timing sensor OUT 72 and advances by the predetermined distance γ1, the READ motor 87 and the intermediate IN motor 86 are turned on to convey the second document G2 in the direction of the READ document glass 110a. Thus, the distance between the rear end of the first document G1 and the forward end of the second document G2 can be made close to 0 mm.

Alternatively, the timing of conveying the preceding document G1 (the first document G1) and the second document G2 may be adjusted in advance in accordance with the result of detection by the paper timing sensor OUT 72 and the result of detection by the paper timing sensor IN 73, thus realizing the state where the distance between the preceding document G (the first document G1) and the second document G2 is close to 0 mm.

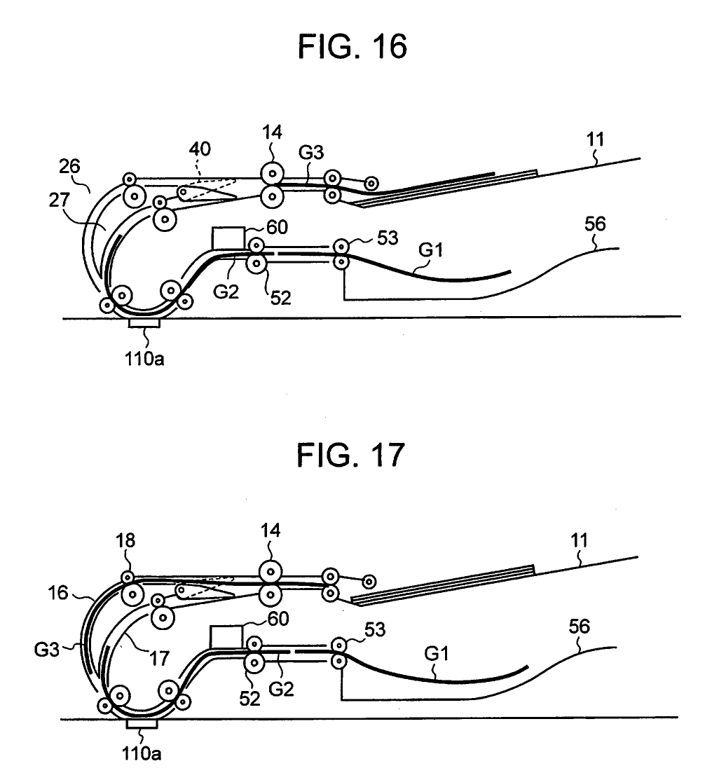

the second document G2 conveyed to the READ document glass 110a after the preceding document G (the first document G1) in ACT258 is conveyed by a predetermined distance (ACT230) and then image scanning on the face side by the scanner 110 is started (ACT231). In parallel, when the rear end of the second document G2 is passed through the registration sensor 71 and the registration sensor 71 changes from on to off, supply of the document G3 as the third sheet (the third document G3) is started. As shown in FIG. 16, the first document G1 is discharged in the direction of the paper discharge tray 56 by the paper discharge rollers 53. The second document G2 travels on the READ document glass 110a. The third sheet of the third document G3 runs into the registration rollers 14 and its forward end position aligned. And then the third document G3 stops.

To convey the third sheet of the document G3 in parallel, as the registration sensor 71 turns on (ACT207), the processing reaches ACT212 via ACT208 and ACT211. In ACT212, if the third document G3 is a sheet of an odd ordinal number, the processing goes to ACT214. In ACT208, the gate solenoid 83 is turned off and the gate 40 is switched in the direction of dividing the third document G3 to the OUT conveying member 26. In ACT214, the registration rollers 14 and the intermediate OUT rollers 18 are rotated to convey the third document G3 to the OUT conveying member 26. As shown in FIG. 17, the first document G1 is set on the paper discharge tray 56. The second document G2 travels on the READ document glass 110a and turns on the paper discharge sensor 78. The third document G3 stops before the pre-scan rollers 50 in the OUT conveying member 26. After that, the third document G3 is conveyed to the READ document glass 110a in the state where the distance from the rear end of the preceding document G (the second document G2) is close to 0 mm.

When the document G is not the final document, ACTs 214 to 221 (conveying of the document G by the OUT conveying member 26) and ACTs250 to 258 (conveying of the document G by the IN conveying member 27) are alternately repeated and the documents are continuously conveyed in the state where the distance between the preceding document and the following document is close to 0 mm (ACT260). When the document G is the final document and the paper discharge sensor 78 turns off (ACT261), the final document is conveyed by a predetermined distance by the paper discharge rollers 53 (ACT262). All the motors and solenoids are turned off (ACT263). Then, conveying of the document by the ADF 10 is completed.

According to this embodiment, in the case of continuously scanning the document G, the two conveying members are used, that is, the OUT conveying member 26 and the IN conveying member 27. While the preceding first document G1 is conveyed by using one conveying member, the next second document G2 is caused to stand by in the other conveying member. The timing when the preceding first document G1 passes through the scanner 110 and the timing when the next second document G2 is conveyed to the scanner 110 are caused to coincide with each other. Thus, the documents G are continuously conveyed in the state where the distance between the preceding first document G1 and the next second document G2 is close to 0 mm.

The document conveying capability of the ADF 10 is enhanced without increasing the conveying speed of the document G. The image scanning speed of the scanner 110 and hence productivity of the image forming apparatus using the scanner 110 can be improved. Moreover, damage to the document G that may occur if the conveying speed is increased can be prevented, and noise can be restrained to a low level.

The invention is not limited to the above embodiment and various modifications can be made without departing from the scope of the invention. For example, the shape and structure of the plural conveying members are not particularly limited. While the distance between the preceding document and the following document is not limited, the document conveying capability can be improved as the distance is closer to 0 mm. Moreover, the structure of the image scanning member for scanning documents may be arbitrary. In embodiments, in order to further miniaturize the device, a small-size CIS may be used instead of the scanner for scanning the face side of the document.

What is claimed is:

1. An auto document feeding device comprising:
plural conveying members which have different paths to reach an image scanning member configured to scan an image on a first side of a document from a document stacking member and which guide the document from the document stacking member to the image scanning member;
a gate member which divides the document passed through a registration roller configured to align a forward end of the document from the document stacking member to one of the plural conveying members; and
a paper discharge member which discharges the document passed through the image scanning member.

2. The device of claim 1, wherein the plural conveying members include a first conveying member and a second conveying member, and the gate member divides the document from the document stacking member to one of the first conveying member and the second conveying member in order.

3. The device of claim 2, wherein the gate member alternately divides the document to the first conveying member or the second conveying member.

4. The device of claim 2, wherein the first conveying member or the second conveying member causes a following document to stand by in the conveying member while a preceding document is scanned by the image scanning member.

5. The device of claim 2, wherein the first conveying member or the second conveying member causes timing when a rear end of the preceding document passes the image scanning member and timing when a forward end of the following document reaches the image scanning member, to coincide with each other.

6. The device of claim 2, wherein the first conveying member has a first timing sensor which detects the document, and the second conveying member has a second timing sensor which detects the document.

7. The device of claim 6, wherein the first conveying member or the second conveying member detects timing when the rear end of the preceding document passes the image scanning member by using the first timing sensor or the second timing sensor, detects timing when the forward end of the following document reaches the image scanning member by using the first timing sensor or the second timing sensor, and causes the timing when the rear end of the preceding document passes the image scanning member and the timing when the forward end of the following document reaches the image scanning member, to coincide with each other.

8. The device of claim 1, further comprising a second image scanning member which scans an image on a second side of the document, in the paper discharge member.

9. The device of claim 8, wherein the image scanning member scans the image on the first side of the document, and the second image scanning member scans the image of the second side of the document.

10. An image scanning device comprising:
an image scanning member which scans an image on a first side of a traveling document;
plural conveying members which have different paths to reach the image scanning member from a document stacking member and which guide the document from the document stacking member to the image scanning member;
a gate member which divides the document passed through a registration roller configured to align a forward end of the document from the document stacking member to one of the plural conveying members; and
a paper discharge member which discharges the document passed through the image scanning member.

11. The device of claim 10, wherein the plural conveying member s include a first conveying member and a second conveying member, and the gate member alternately divides the document from the document stacking member to one of the first conveying member and the second conveying member in order.

12. The device of claim 11, wherein the first conveying member or the second conveying member causes a following document to stand by in the conveying member while a preceding document is scanned by the image scanning member.

13. The device of claim 11, wherein the first conveying member or the second conveying member causes timing when a rear end of the preceding document passes the image scanning member and timing when a forward end of the following document reaches the image scanning member, to coincide with each other.

14. The device of claim 11, wherein the first conveying member has a first timing sensor which detects the document, and the second conveying member has a second timing sensor which detects the document.

15. The device of claim 10, further comprising a second image scanning member along the paper discharge member.

16. The device of claim 15, wherein the second image scanning member scans an image on the document while the paper discharge member discharges the document.

17. The device of claim 15, wherein the image scanning member scans the image on the first side of the document, and the second image scanning member scans the image on a second side of the document.

18. A document feeding method comprising:
dividing an document passed through a registration roller to plural conveying members;
conveying the document divided to the plural conveying members to an image scanning member configured to scan an image of a first side of the document continuously, in order; and
discharging the document passed through the image scanning member.

19. The method of claim 18, wherein timing when a rear-end of the document that precedes passes the image scanning member and timing when a forward end of the document that follows reaches the image scanning member are caused to coincide with each other.

20. The method of claim 18, wherein an image on a second side of the document is scanned by a second image scanning member while the document is discharged.
